(19) United States
(12) Patent Application Publication
(10) Pub. No.: US 2013/0086366 A1
(43) Pub. Date: Apr. 4, 2013

(54) Register File with Embedded Shift and Parallel Write Capability

(71) Applicant: Aaron D. Lamb, San Diego, CA (US)

(72) Inventor: Aaron D. Lamb, San Diego, CA (US)

(73) Assignee: QUALCOMM INCORPORATED, San Diego, CA (US)

(21) Appl. No.: 13/249,358

(22) Filed: Sep. 30, 2011

(51) Int. Cl. G06F 9/305; G06F 9/308

(52) U.S. Cl. 712/221; 712/223; 712/E09.017; 712/E09.018

(57) ABSTRACT

An apparatus includes a register file including a logical circuit. The register file is configured to perform one or more logical operations in conjunction with the logical circuit. The logical operation is performed in response to the register file receiving a register file control instruction. The register file control instruction is independent from an arithmetic logic unit (ALU) control instruction and a multiply-and-accumulate unit (MACU) control instruction.

### TECHNICAL FIELD

The present disclosure relates, in general, to data processing systems and, more specifically, to register files with embedded shift and parallel write capability.

### BACKGROUND

Processing an instruction at a processor may include stages such as fetch (to get the instruction), decode (to break down the instruction into the operation and the operands, (e.g., Operand A plus Operand B), retrieve operands from the register file, execute the instruction, and write back the result (e.g., the sum of Operand A plus Operand B).

General-purpose processors provide defined logic blocks (arithmetic logic units (ALUs), multiply-and-accumulate units (MACs or MACUs), etc.) for performing arithmetic and logical operations. Data to be processed by these logic blocks resides within a register file coupled to the logic blocks. In an exemplary operation, two operands are read from the register file and a result is written back to the register file. Therefore, the operations are generally relegated to selecting source and destination register addresses, as well as performing a logical or arithmetic function Even very simple logical operations may use both the register file and the ALU, rendering both unavailable for other tasks. In addition, while most register files only allow a single register entry to be written, tasks that use the same data for two calculations might require two copies of the same data. An additional clock cycle may be needed to copy from one location to the other, delaying the ALU or MAC hardware from performing additional instructions during that clock cycle.

### SUMMARY

According to some aspects of the disclosure, an apparatus includes a register file having a logical circuit. The register file is configured to perform one or more logical operations. The logical operations are performed in conjunction with the logical circuit in response to the register file receiving a register file control instruction.

According to some aspects of the disclosure, a method includes receiving a register file control instruction. The method may also include performing one or more logical operations. The one or more logical operations are performed in conjunction with a logical circuit of a register file in response to the register file receiving the register file control instruction.

According to some aspects of the disclosure, an apparatus includes means for storing information in a processor including a logical circuit. The storing means is configured to perform one or more logical operations. The one or more logical operations are performed in conjunction with the logical circuit in response to the storing means receiving a control instruction. The apparatus also has means for processing results of the logical operation. The processing means is coupled to the storing means

According to some aspects of the disclosure, an apparatus includes a memory and one or more processors coupled to the memory. The processor(s) is configured to receive a register file control instruction. The processor(s) is further configured to perform one or more logical operations. The logical operations are performed in conjunction with a logical circuit of a register file in response to the register file receiving the register file control instruction.

According to some aspects of the disclosure, a computer program product includes a computer-readable medium having non-transitory program code recorded thereon. The program code includes program code to receive a register file control instruction. The program code also includes program code to perform one or more logical operations. The one or more logical operations are performed in conjunction with a logical circuit of a register file in response to the register file receiving the register file control instruction.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present teachings, reference is now made to the following description taken in conjunction with the accompanying drawings.

FIG. 1 is a block diagram of a microprocessor.

FIG. 2A is a block diagram of an exemplary structure of a register file system according to some aspects of the disclosure.

FIG. 2B is a block diagram of an exemplary structure of a register file system for implementing bit reversal according to some aspects of the disclosure.

FIGS. 2C(i), 2C(ii) and 2C(iii) are exemplary block diagrams of structures of a register file system for implementing shifting according to some aspects of the disclosure.

FIGS. 2D(i), 2D(ii) and 2D(iii) are exemplary block diagrams of structures of a register file system for implementing bi-directional shifting according to some aspects of the disclosure.

FIGS. 2E(i) and 2E(ii) are exemplary block diagrams of structures of a register file system for implementing cascaded shifting according to some aspects of the disclosure.

FIG. 3 is a block diagram of an exemplary register file system implementation according to some aspects of the disclosure.

FIG. 4 illustrates a method according to an aspect of the disclosure.

FIG. 5 is a block diagram of a particular aspect of a wireless device including a processor operable to execute an instruction identifying a register and a memory location.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

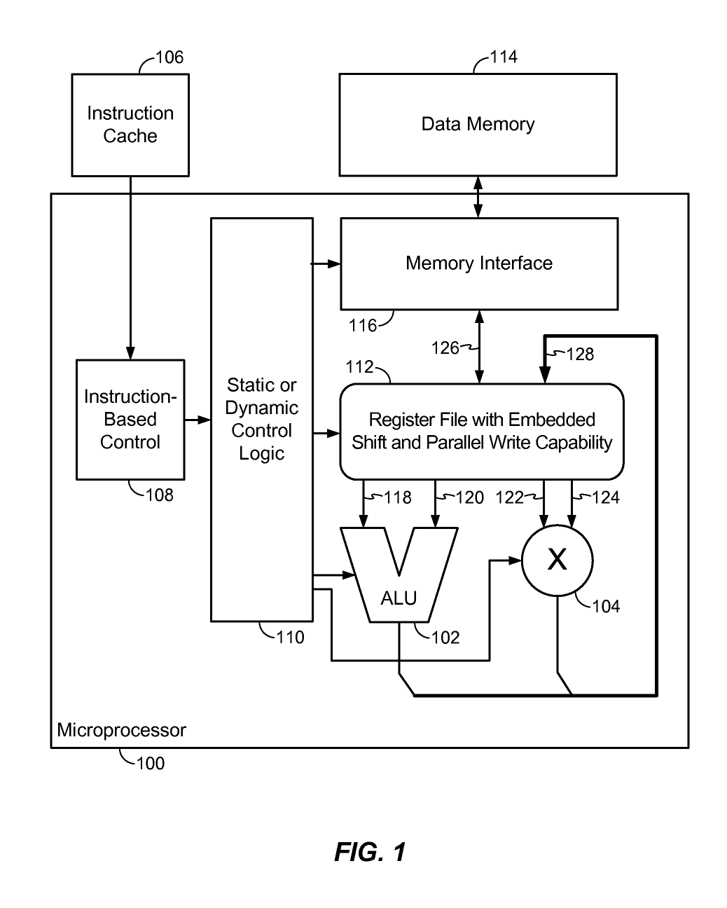

FIG. 1 illustrates a block diagram of a microprocessor according to some aspects of the disclosure. In general, the microprocessor 100 provides defined logic blocks (ALU 102, MAC 104, etc.) for performing arithmetic and logical operations. Before an instruction can be executed, program instructions are placed into an instruction cache 106 from an input device or a secondary storage device. A control unit includes an instruction based control 108 and a control logic 110. The control logic 110 provides control instructions or commands to a register or register file 112, a memory interface 116, the ALU 102 and/or the MAC 104 for initiating the operations of the microprocessor, for example.

Data to be operated on by the logic blocks generally resides within the register file 112 coupled to the logic blocks (ALUs 102, MACs 104, etc.), in which two input data are read from the register file 112 and one result is written back to the register file 112. The register file 112 may be separate from but coupled to a data memory 114 via a memory interface 116. The register file 112 provides high speed memory storage for the microprocessor 100. The register file 112 may include general purpose registers for storing the input data and results for the MAC 104 and ALU 102. The ALU 102 may be coupled to the register file 112 to provide arithmetic computations for data stored in the register file 112. The register file 112 may include output ports 118, 120, 122 and 124 and input ports 126 and 128. In other aspects, the register file 112 may have any number of input and output ports.

For the MAC 104, a multiplier receives and multiplies two input data from the output ports 122 and 124 of the register file 112 and provides an output to the input port 128. The ALU 102 receives two inputs from the output ports 118 and 120 of the register file 112 and provides an output to the input port 128. The register file 112 can also receive data at an input port 126 from the data memory 114 via the memory interface 116.

The control instructions for the memory interface 116 may be independent of the ALU/MAC control instructions. The associated logical operations associated with the memory interface 116 are also independent of the ALU 102 or MAC 104 of the microprocessor 100. In some aspects, the microprocessor 100 may be configured to statically or pseudo-statically control data blocks of one or more register files 112 instead of receiving instructions associated with the ALU 102 or MAC 104 every clock cycle that controls the operation of the one or more register files 112. For example, the register file 112 may not need to receive new instructions every cycle. The register file 112 can be controlled on an instruction by instruction basis, but can also be controlled by a less frequent control mechanism. For example, a particular instruction may indicate that the register file be set to a fixed state that is independent of future instructions until the configuration is changed.

The register file 112 may be configured with embedded shift and parallel write capability based on independent control from the control unit. For example, the register file 112 can receive command instructions that allow all entries of the register file 112 or a subset of the registers file 112 to perform functions, e.g., shifting, in parallel with functions dependent on the ALU 102 and/or MAC 104 control instructions. The functions may include write-back of results from the ALU 102 or the MAC 104. Therefore, simple logical operations, for example, can be performed without the interaction with the ALU 102, MAC 104, or other logical/arithmetic-function blocks on the microprocessor 100. Additionally, within the same context, the register file 112 can save its input data to multiple locations simultaneously. These independently controlled functions of the register file 112 allow the ALU 102 and MAC 104 to perform other instructions simultaneously.

Each logical operation of the register file 112 can include a different control command or instruction. In some aspects, control instructions may be based on a static configuration implemented on the register file 112 that may be valid for a period of time or controlled through a simple sequence. The independent operations of the register file 112 may be implemented based on a control instruction, a time multiplexed instruction or a discrete multiplexed function. For example, a register file logical operation may be configured to execute once out of every X clock cycles; where X represents a number of clock cycles, e.g., 8. In some aspects, the command or control instruction can be in the form of data, e.g., an operand, configured to provide control sent to the memory interface 116, e.g., to select lines of a multiplexer. In other aspects, control may be implemented as an instruction opcode. Configuration flip-flops or latches may also control the select lines on multiplexers to control the inputs to the register file 112 during static or pseudo static control of the register files.

In some aspects, the register implementation of the microprocessor 100 can be implemented in, e.g., very long instruction word (VLIW) processors. The VLIW architecture is suitable for this register implementation because it is based on a predictable data stream and may include several parallel processing data paths. The register implementation in conjunction with a microprocessor allows other operations that are generally performed by other parallel data path components such as an ALU 102, a MAC 104 or a shifter to be performed by the register file 112. Such an implementation allows the parallel data path components to perform other computations. Therefore, for the same clock speed of the overall microprocessor hardware, the register implementation yields an improved computational efficiency.

In general, processor design minimizes the number of instruction bits to describe ALU 102, MAC 104, or other functional unit operations, with none leftover for flexible control of the register file. A control path based on the control instructions from the control unit may allow for static or pseudo-static control of substantially all functional units in parallel with control associated with the ALU 102 and the MAC 104. Therefore, the number of bits to control the register file 112 need not adhere to the same limits and optimizations of the general processor. In other words, the register file 112 does not need an instruction every clock. Rather, instruction control bits representing “1-of-many” options fetched every clock cycle are replaced with parallel control bits from the control logic 110, for example, which are not generally updated during the execution of the algorithm (thus, statically or pseudo-statically configured). The above solution results in a higher performance processor with higher hardware utilization efficiency that may reduce the number of “overhead” instructions and reduce constraints on bandwidth for controlling data path. In particular, with a small amount of additional hardware, in conjunction with independent control from the control unit, basic functions can be implemented to offload some of the microprocessors tasks to the register file 112.

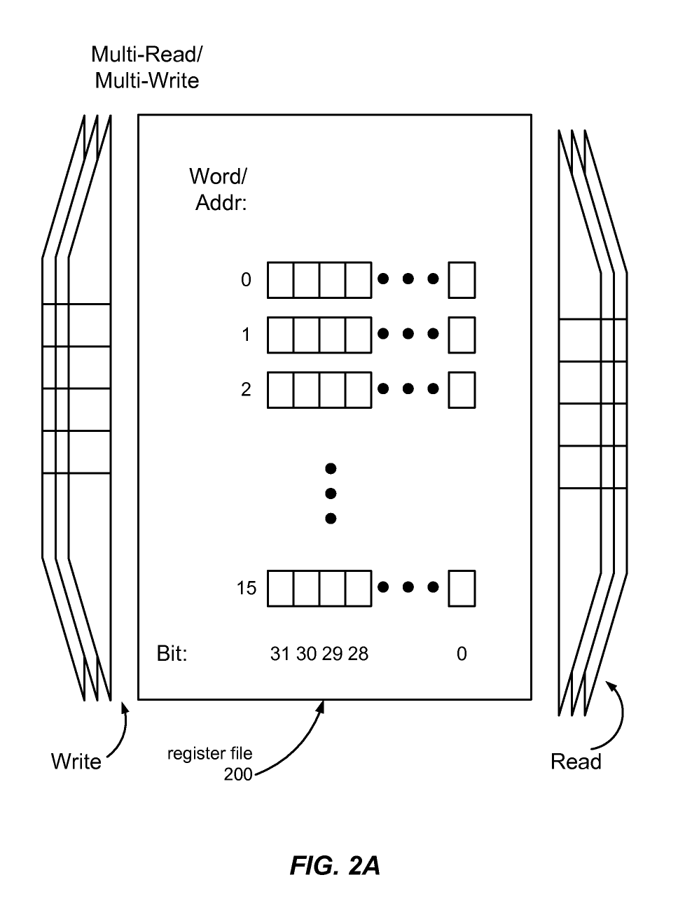

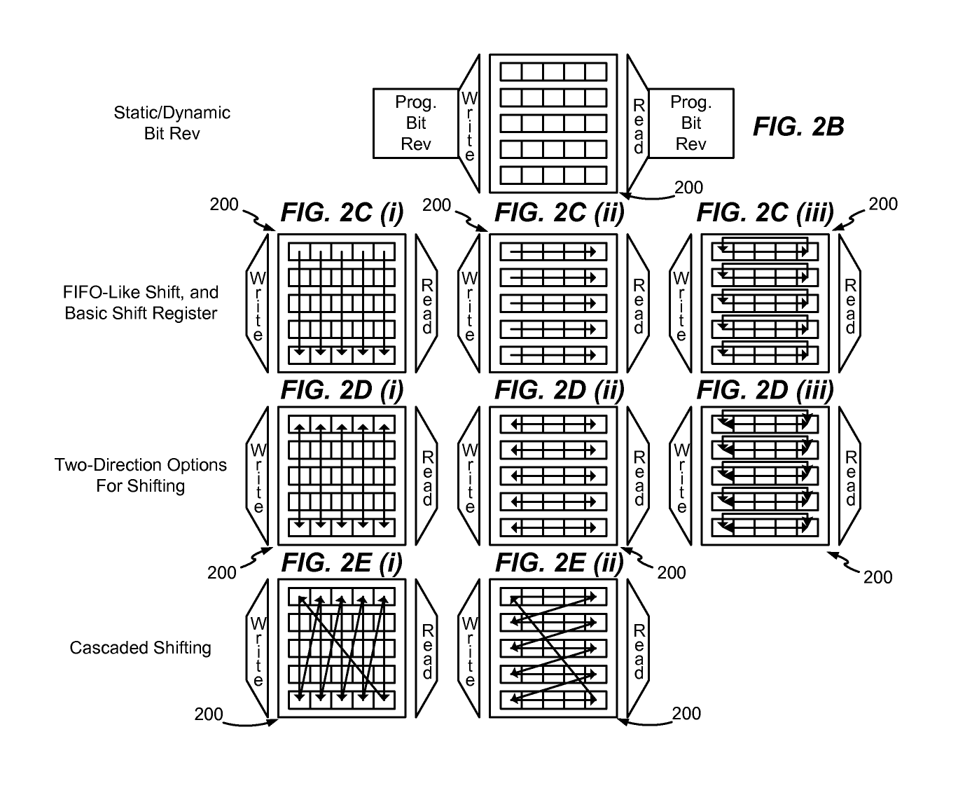

FIGS. 2A to 2E illustrate exemplary register file system implementations that are substantially independent of the ALU 102 and/or MAC 104.

The register file system in FIGS. 2A to 2E are configured to function based on control that is independent of the control associated with the ALU 102 and/or MAC 104. FIG. 2A illustrates a basic structure of a register file 200 with multi read and multi write capability. The register file structure or system can be implemented in different ways such as in data flip-flops (DFFs), latches, or random access memory blocks. Each row (0-15) represents a separate word of a register file 200 and each column (31-0) represents a single bit within the word. While FIG. 2A illustrates 16 entry register files with 32 bits for each word, the register file 200 is not limited in size and may include any width of data word and any number of entries. For example, FIGS. 2B to 2E illustrates 5 entry register files with 5 bits for each word.

Bit reversing on the data can occur during a write operation or a read operation (FIG. 2B). In some aspects, command instructions from the control logic 110 are received at the register file system to initiate bit reversing at the register file 200. When bit reversing is implemented in the register file, a transmission gate of the register file may be driven by multiplexers, which may select between multiple entries in the register file 200. As previously described, the instructions for controlling the register file 200 or 118 may be generated by the control unit. The bit reverse implementation may generally be used in deinterleaving applications in fast Fourier transforms (bit reverse address) as part of an algorithm or method.

FIG. 2C illustrates various shifts that can be implemented according to some aspects of the disclosure. In some aspects, a data word shift can be executed according to a first in first out (FIFO) implementation (FIG. 2C (i)). In this case, the data bit in each column is shifted in the direction of the arrows based on the independent control associated with the register system. Right shifting of individual bits of each word can be implemented in the direction of the arrow as illustrated in FIG. 2C (ii). On every shift, the contents of a bit section are replaced by the contents of the bit section to its left. In some aspects, a right shift operation has the effect of successively dividing a binary number by two. If the operation is reversed (left shift), this has the effect of multiplying the number by two, for example. A divide by two function can be executed based on a circular FIFO implementation as illustrated in FIG. 2C (iii). In this case, the data bits move from left to right in each word. On every shift, the contents of a given bit section are replaced by the contents of the bit section to its left. The data moves from the left to the right and wrap around from right to left. Therefore, the leftmost bit section receives its inputs from the rightmost bit section of a row.

The directional movement of the data through the register file can be either to the left (i.e., left shifting), to the right (i.e., right shifting), and/or left-in but right-out (i.e., rotation). In some aspects, the directional movement of data through the register file includes both left and right shifting within the same register thereby making it bidirectional (FIG. 2D). In FIG. 2D, the words and bits shift similar to the shifts in FIG. 2C but in both directions.

FIG. 2E illustrates cascaded shifting of the bits or data between data words and among data words in the register file. For example, in FIG. 2E(i), the contents of the first four bits of each column of the register file 200 are shifted down. In the same context, the contents of the last bit of each column of the register file 200 are shifted to the first bit section of next column (with the last bit of the last column shifting to the first bit of the first column). In some aspects, the data word in the first column is shifted rightward. The last bit of each row shifts to the first bit of the next row down. The last bit of the bottom row shifts to the first bit of the first row. For example, in FIG. 2E (ii), the data bits move from left to right. On every shift, the contents of a given bit section are replaced by the contents of the bit section to its left. The leftmost bit section of the first column receives its inputs from the rightmost bit section of a row above it. In some aspects, the leftmost bit section of the first row receives is content from the last bit section of the last column. While the features of FIGS. 2A to 2E are illustrated independently, the register file 200 can implement any one or a combination of the features.

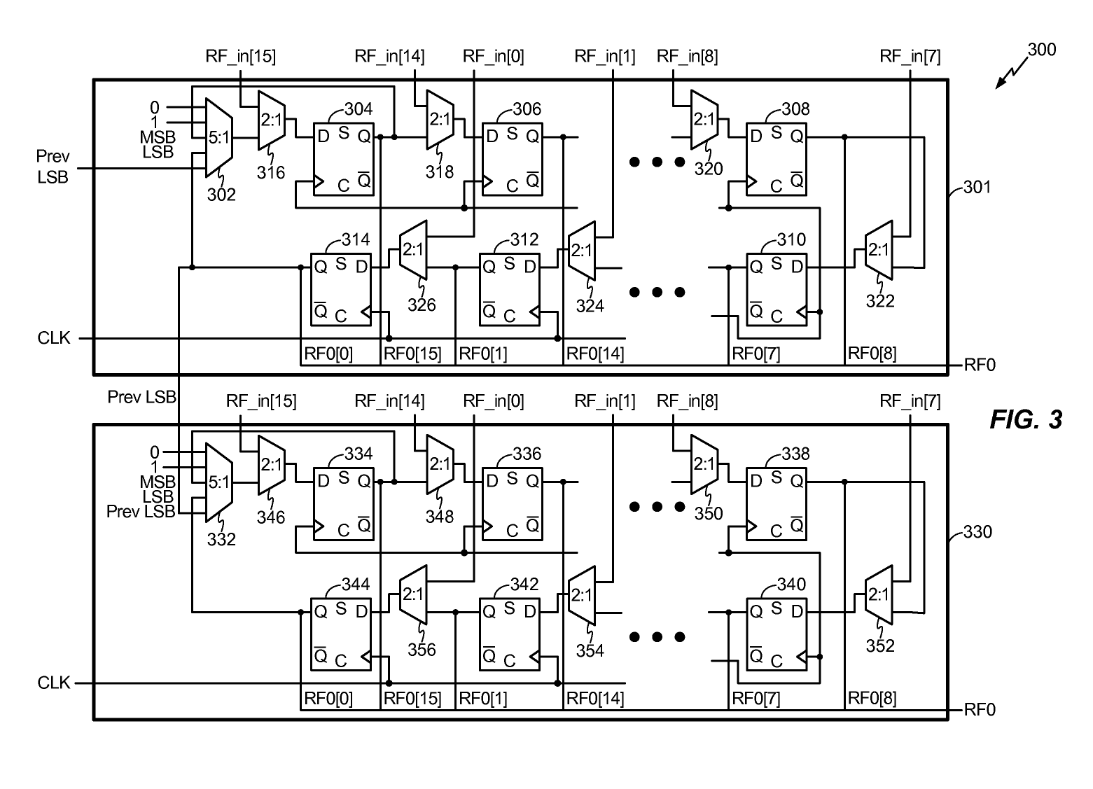

FIG. 3 illustrates an exemplary register file system 300 implementation according to some aspects of the disclosure. For explanatory purpose, FIG. 3 shows a circuit to implement the register file systems of FIGS. 2C(ii), 2C(iii) and 2E(ii). Each box 301, 330 represents a single row (i.e., word) in a register file system 300. In FIG. 3, each word is 16 bits. The first bit receives input from a 5 to 1 multiplexor 302, 332.

Each word 301, 330 includes several single bit D-Type Data Latches or flip flops 304-314 and 334-344 connected together in a serial or daisy-chain arrangement. Each word 301, 330 also include 2:1 multiplexers 316-326 and 346-356 coupled to the input of each data latch/flip flop 304-314 and 334-344. Thus, output from one data latch/flip flop 304-314 and 334-344 becomes the input of the 2:1 multiplexor 316-326 and 346-356 associated with the next latch 304-314 and 334-344 and so on. The input to each 2:1 multiplexer 316-326 and 346-356 also includes new register file (RF) data input RF_in[0], RF_in[1], RF_in[7], RF_in[8], RF_in[14], RF_in[15]. The 2:1 multiplexer selects between either the new data or the output from a previous data latch 304-314 and 334-344.

Although a 2:1 multiplexer is shown for each data latch 304-314 and 334-344, aspects of the disclosure are not limited to a specific size of a multiplexer. For example, the size of the multiplexers may vary depending on the function implemented by the register file. The multiplexer or multiplexing logic may be integrated in the memory interface 116 or may be independent but coupled to the memory interface 116.

The leftmost 2:1 data multiplexor 316, 346 receives input from a 5:1 multiplexor 302, 332, rather than input directly from a previous latch. Thus, the leftmost multiplexor 316, 346 outputs either new data from RF_in[15] (register file input bit 15) or the output from the 5:1 multiplexor 302, 332.

The 5:1 multiplexor 302, 332 controls input to the leftmost 2:1 multiplexor 316, 346 to change the function of the register file. For example, data already in the flip flops 304-314 and 334-344 can shifted from left to right toward the least significant bit (LSB) in one clock cycle (as seen in FIG. 2C(ii)). In particular, the latches or flip flops 304, 334, for example, shift their output, Q, to flip flops 306, 336 (respectively) via the 2:1 multiplexor 318, 348. The latches or flip flops 306, 336, for example, shift their output Q to flip flops 308, 338 (respectively) via the 2:1 multiplexor 320, 350 and so on. A “0” or a “1” (depending on the function implemented by the register file) can be inserted at the MSB location (i.e., at the leftmost flip flops 304, 334) that may be otherwise void due to the right shift of data already in the MSB. The “0” or “1” is selected as a dummy bit for the flip flops 304, 334.

By selecting other inputs from the 5:1 multiplexors 302, 332, other functions can be achieved. For example, when the most significant bit (MSB) is selected at the 5:1 multiplexor 302, 332, the shift register performs right shifts with the value at the MSB (i.e., leftmost flip flops 304, 334) fed back into the input of the leftmost flip flops 304, 334. In particular, leftmost flip flops 304, 334 retain their value. This implementation is a right shift with sign extension. Thus, the selection of a “0”, “1” or MSB at the 5:1 multiplexor 302, 332 results in shifting functions corresponding to those illustrated with respect to FIG. 2C(ii), for example.

Similar to the right shift implementation of FIG. 2C(i), when an LSB is selected at the 5:1 multiplexor 302, 332, data already in the flip flops 304-314 and 334-344 is shifted from left to right toward the LSB in one clock cycle. However, in this case, the output of the LSB (i.e., data currently in the rightmost flip flops 314, 344) is selected at the 5:1 multiplexor 302, 332 and subsequently input to the leftmost latch 304, 334. This circular shifting implementation corresponds to the shifting illustrated in FIG. 2C(iii) where data from the LSB is fed into the MSB.

When a previous least significant bit (LSB) (“prey LSB”) is selected at the 5:1 multiplexors 302, 332, the register file system can perform circular shifting on concatenated entries in the register file, to achieve a function corresponding to the function shown in FIG. 2E(ii). In this implementation, the flip flop 304, for example, shifts its output to the flip flop 306 and so on until the output data is shifted to the final flip flop 314 in the chain of the first row 330. The output of the final flip flop 314 is circulated to the prey LSB input of the 5:1 multiplexor 332 and subsequently to the flip flop 334 via the 2:1 multiplexor 346. The flip flop 334 then shifts its output to flip flop 336 and so on until the output data is shifted to the final flip flop 344 in the chain. The process continues until the output data is shifted to the right most flip flop (LSB) at the end of the last word or row (not shown) of the register file system. The output of this rightmost flip flop of the last word or row is fed back into the 5:1 multiplexor 302 (i.e., prey LSB) and subsequently to the leftmost flip flop 304 of the first word or row 301.

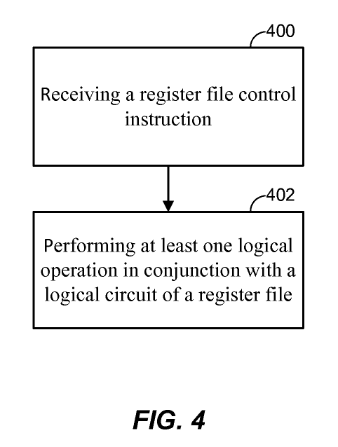

FIG. 4 illustrates a method according to an aspect of the disclosure. At block 400, the method starts with receiving a register file control instruction. At block 402, the method includes performing one or more logical operations in conjunction with a logical circuit of a register file. The logical operations are performed in response to the register file receiving the register file control instruction.

In one configuration, the apparatus includes means for for storing information in a processor including a logical circuit. In one aspect of the disclosure, the information storing means may be the register file 112, the register file 200, the register 560 and/or the register file system 300 configured to perform the functions recited by the information storing means. The apparatus may also include processing means. The processor may be the microprocessor 100. Tn another aspect, the aforementioned means may be a module or any apparatus configured to perform the functions recited by the aforementioned means.

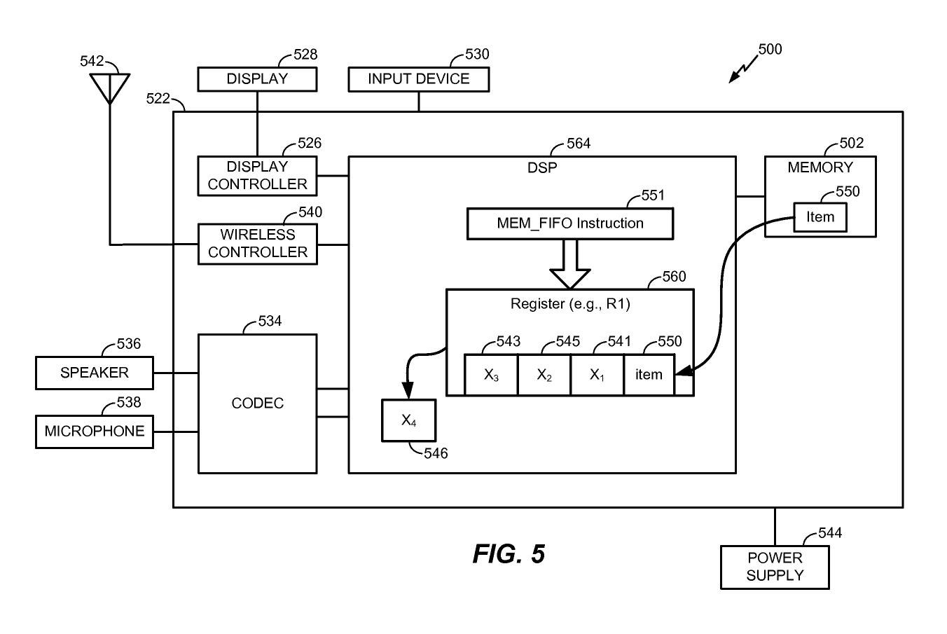

Referring to FIG. 5, a block diagram of a particular illustrative aspect of a wireless device that includes a memory storing a FIFO load instruction identifying a register and a memory location is depicted and generally designated 500. The device 500 includes a processor, such as a digital signal processor (DSP) 564, coupled to a memory 502. In a particular aspect, the memory 502 stores and may transmit instructions executable by the DSP 564, such as the FIFO load instruction 551. The memory 502 may also store data to be loaded, such as the item 550. The DSP may include the register 560, which stores data 546, 543, 545, 541 (i.e., “X₄ . . . . X₁”), representing a FIFO buffer. Upon execution of the FIFO load instruction 551, the item 550 may be loaded from a memory location in the memory 502 and a shift and insert operation may be performed to shift the data 546, 543, 545, 541 in the register 560 and to insert the item 550 into the register 560. For example, in FIG. 5, a shift left operation may be performed on the data 546, 543, 545, 541, resulting in the removal of the data X₄ 546 from the register 560, and the item 550 may be inserted into the register 560 at the least significant portion of the register 560. Alternately, the data 546, 543, 545, 541 in the register 560 may be shifted right (not shown), resulting in the removal of the data X₁ 541 from the register 560, and the item 550 may be inserted into the register 560 at the most significant portion of the register 560.

FIG. 5 also shows a display controller 526 that is coupled to the DSP 564 and to a display 528. A coder/decoder (CODEC) 534 (e.g., an audio and/or voice CODEC) can be coupled to the DSP 564. For example, the CODEC 534 may cause execution of the FIFO load instruction 551 as part of an encoding or decoding process. Other components, such as the display controller 526 (which may include a video CODEC and/or an image processor) and a wireless controller 540 (which may include a modem) may also cause execution of the FIFO load instruction 551 during signal processing. A speaker 536 and a microphone 538 can be coupled to the CODEC 534. FIG. 5 also indicates that the wireless controller 540 can be coupled to a wireless antenna 542. In a particular aspect, the DSP 564, the display controller 526, the memory 502, the CODEC 534, and the wireless controller 540 are included in a system-in-package or system-on-chip device 522.

In a particular aspect, an input device 530 and a power supply 544 are coupled to the system-on-chip device 522. Moreover, in a particular aspect, as illustrated in FIG. 5, the display 528, the input device 530, the speaker 536, the microphone 538, the wireless antenna 542, and the power supply 544 are external to the system-on-chip device 522. However, each of the display 528, the input device 530, the speaker 536, the microphone 538, the wireless antenna 542, and the power supply 544 can be coupled to a component of the system-on-chip device 522, such as an interface or a controller.

It should be noted that although FIG. 5 depicts a wireless communications device, the DSP 564 and the memory 502 may also be integrated into a set-top box, a music player, a video player, an entertainment unit, a navigation device, a personal digital assistant (PDA), a fixed location data unit, or a computer. A processor (e.g., the DSP 564 or a processor including the microprocessor 100 of FIG. 1) may also be integrated into such a device.

Although specific circuitry has been set forth, it will be appreciated by those skilled in the art that not all of the disclosed circuitry is required to practice the disclosed embodiments. Moreover, certain well known circuits have not been described, to maintain focus on the disclosure.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine or computer readable medium tangibly embodying instructions may be used in implementing the methodologies described herein. For example, software code may be stored in a memory and executed by a processor. When executed by the processor, the executing software code generates the operational environment that implements the various methodologies and functionalities of the different aspects of the teachings presented herein. Memory may be implemented within the processor or external to the processor.

As used herein, the term “memory” refers to any type of long term, short term, volatile, nonvolatile, or other memory and is not to be limited to any particular type of memory or number of memories, or type of media upon which memory is stored.

The machine or computer readable medium that stores the software code defining the methodologies and functions described herein includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. As used herein, disk and/or disc includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present teachings and their advantages have been described in detail, it should be understood that various changes, substitutions and alterations can be made herein without departing from the technology of the teachings as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present teachings. Accordingly, the appended claims are intended to include within their scope such processes, machines, manufacture, compositions of matter, means, methods, or steps.

What is claimed is:

1. An apparatus comprising:
a register file including a logical circuit, the register file configured to perform at least one logical operation in conjunction with the logical circuit in response to the register file receiving a register file control instruction.

2. The apparatus of claim 1, in which the at least one logical operation is one of: and, or, xor, shift, rotate, bit reverse and invert.

3. The apparatus of claim 1, in which the logical circuit comprises a multiplexer, the multiplexer configured to facilitate performance of the logical operation, the multiplexer being independent from an arithmetic logic unit (ALU) and a multiply-and-accumulate unit (MACU).

4. The apparatus of claim 1, in which the register file is configured to perform the at least one logical operation on a plurality of data words in parallel.

5. The apparatus of claim 1, in which the register file is configured to perform logical operations in parallel with operations being performed by one of an arithmetic logic unit (ALU) and a multiply-and-accumulate unit (MACU).

6. The apparatus of claim 1, in which the register control instruction is based on one of a time multiplexed instruction, an operand that controls select lines of a multiplexer, an opcode and flip flops that control the select lines of multiplexers.

7. The apparatus of claim 1, in which the register file is configured to perform an operation independent from an arithmetic logic unit (ALU) and a multiply-and-accumulate unit (MACU) control, the operation being performed in one of every plurality of clock cycles.

8. The apparatus of claim 1, in which the at least one logical operation comprises a plurality of same logical operations performed during multiple clock cycles in response to the register file control instruction.

9. The apparatus of claim 1, in which the register file control instruction is independent from an arithmetic logic unit control instruction and a multiply-and-accumulate unit control instruction.

10. The apparatus of claim 1, integrated into at least one of a mobile phone, a set top box, a music player, a video player, an entertainment unit, a navigation device, a computer, a hand-held personal communication systems (PCS) unit, a portable data unit, and a fixed location data unit.

11. A method comprising:
receiving a register file control instruction; and
performing at least one logical operation in conjunction with a logical circuit of a register file in response to the register file receiving the register file control instruction.

12. The method of claim 11, in which performing at least one logical operation comprises performing one of anding, oring, xoring, shifting, rotating, bit reversing and inverting.

13. The method of claim 11, further comprising performing the at least one logical operation by the register file on a plurality of data words in parallel.

14. The method of claim 11, further comprising performing logical operations in parallel with operations being performed by one of an arithmetic logic unit (ALU) and a multiply-and-accumulate unit (MACU).

15. The method of claim 11, further comprising performing an operation independent from an arithmetic logic unit (ALU) and a multiply-and-accumulate unit (MACU) control, the operation being performed on one of every plurality of clock cycles.

16. The method of claim 11, The apparatus of claim 1, in which the at least one logical operation comprises a plurality of same logical operations performed during multiple clock cycles in response to the register file control instruction.

17. The method of claim 11, further comprising executing the logical operation in at least one of a mobile phone, a set top box, a music player, a video player, an entertainment unit, a navigation device, a computer, a hand-held personal communication systems (PCS) unit, a portable data unit, and a fixed location data unit.

18. An apparatus comprising:
means for storing information in a processor including a logical circuit, the storing means configured to perform at least one logical operation in conjunction with the logical circuit in response to the storing means receiving a control instruction; and
means for processing results of the logical operation, the processing means being coupled to the storing means.

19. The apparatus of claim 18, integrated into at least one of a mobile phone, a set top box, a music player, a video player, an entertainment unit, a navigation device, a computer, a hand-held personal communication systems (PCS) unit, a portable data unit, and a fixed location data unit.

20. A computer program product, comprising:
a computer-readable medium having non-transitory program code recorded thereon, the program code comprising:
program code to receive a register file control instruction; and
program code to perform at least one logical operation in conjunction with a logical circuit of a register file in response to the register file receiving the register file control instruction.

21. The computer program product of claim 20, integrated into at least one of a mobile phone, a set top box, a music player, a video player, an entertainment unit, a navigation device, a computer, a hand-held personal communication systems (PCS) unit, a portable data unit, and a fixed location data unit.
